(19) United States
(12) Patent Application Publication
(10) Pub. No.: US 2016/0070467 A1
(43) Pub. Date: Mar. 10, 2016

(54) ELECTRONIC DEVICE AND METHOD FOR DISPLAYING VIRTUAL KEYBOARD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-HUA HSU, New Taipei (TW); YANG-YANG CHEN, Shenzhen (CN)

(21) Appl. No.: 14/713,381

(22) Filed: May 15, 2015

(30) Foreign Application Priority Data
Sep. 9, 2014 (CN) 201410454454.6

(51) Int. Cl. G06F 3/0488

(52) U.S. Cl. CPC G06F 3/04886

(57) ABSTRACT

A method for displaying virtual keyboard in an electronic device can show a pair of virtual sub-keyboards each having predetermined key configuration structure on a touch screen of the electronic device, and move at least one virtual sub-keyboard with an input device to a target position where the input device stops, in response to a user operation for moving the at least one virtual sub-keyboard.

### CROSS-REFERENCE TO RELATED APPLICATIONS

This application claims priority to Chinese Patent Application No. 201410454454.6 filed on Sep. 9, 2014, the contents of which are incorporated by reference herein.

### FIELD

The subject matter herein generally relates to user interface management, and particularly to an electronic device and a method for displaying virtual keyboard.

### BACKGROUND

Electronic devices including touch screens usually receive input information through virtual keyboards which are displayed on the touch screens. Existing virtual keyboards have standard keys configuration structure and are displayed in fixed position of the touch screen.

### BRIEF DESCRIPTION OF THE DRAWINGS

Implementations of the present disclosure will now be described, by way of example only, with reference to the attached figures.

FIG. 1 is a block diagram of one example embodiment of an electronic device including a virtual keyboard displaying system.

FIG. 2 is a diagrammatic view of one example embodiment of a pair of virtual sub-keyboards displayed in the electronic device of FIG. 1.

FIG. 3 is a flowchart of one example embodiment of a method for displaying virtual keyboard in the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “comprising” means “including, but not necessarily limited to”; it specifically indicates open-ended inclusion or membership in a so-described combination, group, series and the like. The term “module” refers to logic embodied in hardware or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

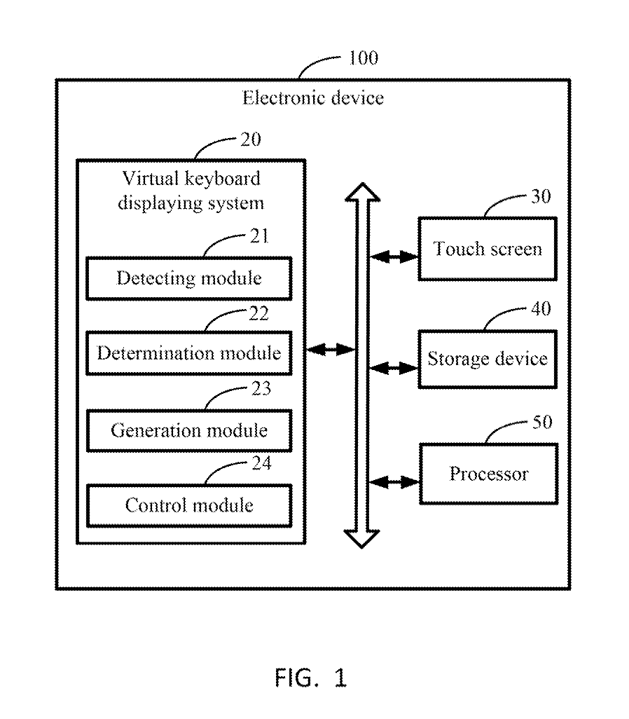

FIG. 1 is a block diagram of an example embodiment of an electronic device. In at least one embodiment as shown in FIG. 1, an electronic device 100 includes, but is not limited to, a virtual keyboard displaying system 20, a touch screen 30, a storage device 40, and at least one processor 50. The virtual keyboard displaying system 20 is coupled to the touch screen 30, the storage device 40, and the at least one processor 50. FIG. 1 illustrates only one example of the electronic device 100, other examples can comprise more or fewer components than illustrated, or have a different configuration of the various components.

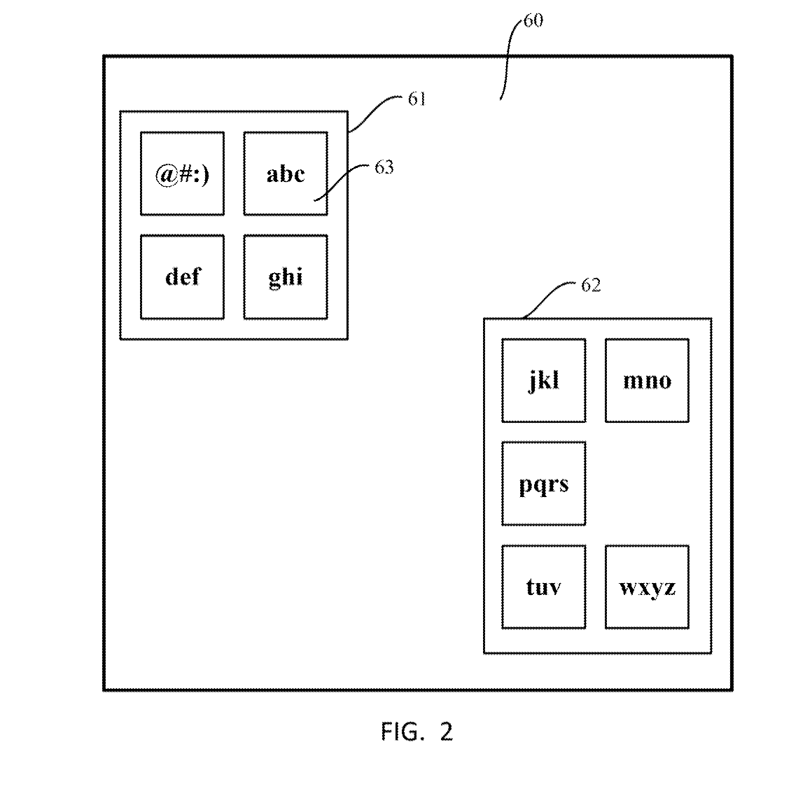

In one embodiment, the electronic device 100 can be mobile phones, personal computers, tablet computers, or any other suitable electronic devices. The touch screen 30 can display an information input interface 60 (as shown in FIG. 2) of the electronic device 100 and receive information input by an input device (not shown), such as a finger or a stylus.

The storage device 40 can be an internal storage device, such as a flash memory, a random access memory (RAM) for temporary storage of information, and/or a read-only memory (ROM) for permanent storage of information. The storage device 40 can also be an external storage device, such as an external hard disk, a storage card, or a data storage medium. The at least one processor 50 can be a central processing unit (CPU), a microprocessor, or other data processor chip that performs functions of the electronic device 100.

In one embodiment, the virtual keyboard displaying system 20 can show a pair of virtual sub-keyboards each having predetermined key configuration structure on the touch screen 30, and move at least one virtual sub-keyboard with an input device to a target position where the input device stops, in response to a user operation for moving the at least one virtual sub-keyboard.

In at least one embodiment, the virtual keyboard displaying system 20 can include a detecting module 21, a determination module 22, a generation module 23, and a control module 24. Modules 21-24 can comprise computerized instructions in the form of one or more computer-readable programs that can be stored in a non-transitory computer-readable medium, for example in the storage device 40, and are executed by the at least one processor 50 of the electronic device 100 to provide functions of the present disclosure. A detailed description of the functions of the modules 21-24 is given below in reference to FIG. 1.

In the embodiment, the storage device 40 stores information regarding a first predetermined user operation for rendering a pair of virtual sub-keyboards, and information regarding a second predetermined user operation for selecting and moving at least one virtual sub-keyboard.

In the embodiment, as shown in FIG. 2, the detecting module 21 detects a user operation applied to the information input interface 60 which is displayed on the touch screen 30, and obtains information regarding the detected user operation.

The determination module 22 determines whether the obtained information regarding the detected user operation matches the prestored information regarding the first predetermined user operation for rendering a pair of virtual sub-keyboards. In the embodiment, the first predetermined user operation can be touching the information input interface at two opposite sides of the touch screen 30, for example, a long press, a click, a double click, or a predetermined input gesture to the information input interface at two opposite sides of the touch screen 30.

If the determination module 22 determines that the obtained information regarding the detected user operation matches the prestored information regarding the first predetermined user operation, the generation module 23 generates a pair of virtual sub-keyboards 61 and 62 each having predetermined key configuration structure, and the control module 24 renders the pair of virtual sub-keyboards on two opposite sides of the touch screen 30, for example, the left side and the right side of the touch screen 30, or the top and the bottom of the touch screen 30. In the embodiment, a combination of keys 63 of the pair of virtual sub-keyboards 61 and 62 is equivalent to keys of a standard virtual keyboard (not shown).

In other embodiments, the storage device 40 further stores information regarding a third predetermined user operation for rendering a standard virtual sub-keyboard. The third predetermined user operation can be touching the information input interface, for example, a long press, a click, a double click, or a predetermined input gesture to the information input interface.

If the determination module 22 determines that the obtained information regarding the detected user operation matches information regarding the third predetermined user operation, the generation module 23 generates a standard virtual sub-keyboard having predetermined key configuration structure, and the control module 24 renders the standard virtual sub-keyboard on a fixed position of the touch screen 30, for example, the bottom side of the touch screen 30.

In the embodiment, the detecting module 21 further detects a user operation applied to the information input interface 60 after the pair of virtual sub-keyboards 61 and 62 are rendered, and obtains information regarding the detected user operation.

The determination module 22 further determines whether the obtained information regarding the detected user operation matches the prestored information regarding a second predetermined user operation for selecting and moving at least one virtual sub-keyboard. In the embodiment, the second predetermined user operation can be touching and dragging one or both of the virtual sub-keyboards 61 and 62.

If the determination module 22 determines that the obtained information regarding the detected user operation matches the prestored information regarding the second predetermined user operation, the control module 24 moves the selected virtual sub-keyboard 61 or/and 62 with the input device, such as a finger or a stylus, to a target position where the input device stops.

In other embodiments, the detecting module 21 further detects whether one of the pair of virtual sub-keyboards is moved to contact the other. If the detecting module 21 detects that one of the pair of virtual sub-keyboards is moved to contact the other, the control module 24 renders the standard virtual sub-keyboard to replace the pair of virtual sub-keyboards 61 and 62.

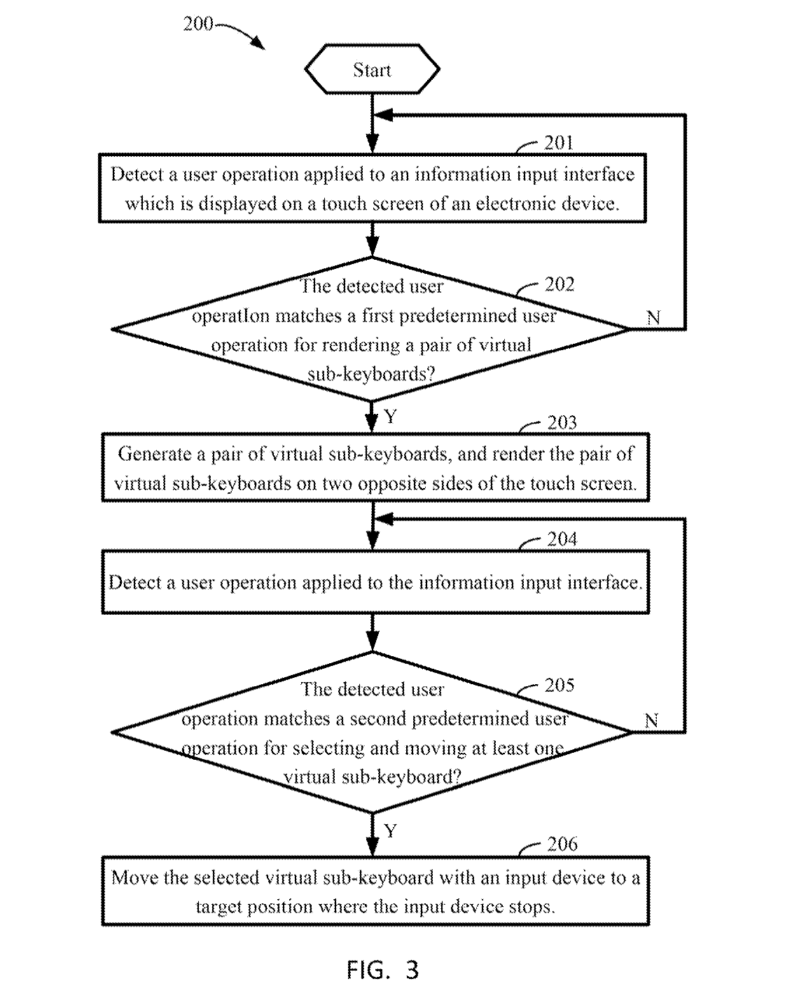

FIG. 3 illustrates a flowchart of an example embodiment of a method for displaying virtual keyboard in an electronic device. In an example embodiment, the method 200 is performed by execution of computer-readable software program codes or instructions by at least one processor of the electronic device.

Referring to FIG. 3, the flowchart is presented in accordance with an example embodiment which is being thus illustrated. The example method 200 is provided by way of example, as there are a variety of ways to carry out the method. The method 200 described below can be carried out using the configurations illustrated in FIG. 1, for example, and various elements of these figures are referenced in explaining method 200. Each block shown in FIG. 3 represents one or more processes, methods, or subroutines, carried out in the exemplary method 200. Furthermore, the illustrated order of blocks is by example only and the order of the blocks can change. Additional blocks can be added or fewer blocks can be utilized without departing from this disclosure. The example method 200 can begin at block 201.

At block 201, a detecting module detects a user operation applied to an information input interface which is displayed on a touch screen of the electronic device, and obtains information regarding the detected user operation.

At block 202, a determination module determines whether the obtained information regarding the detected user operation matches prestored information regarding a first predetermined user operation for rendering a pair of virtual sub-keyboards. In the embodiment, the information regarding the first predetermined user operation can be prestored in a storage device of the electronic device, and the first predetermined user operation can be touching the information input interface at two opposite sides of the touch screen, for example, a long press, a click, a double click, or a predetermined input gesture to the information input interface at two opposite sides of the touch screen.

If the obtained information regarding the detected user operation matches the prestored information regarding the first predetermined user operation, block 203 is implemented. Otherwise the process goes back to block 201.

At block 203, a generation module generates a pair of virtual sub-keyboards each having predetermined key configuration structure, and a control module renders the pair of virtual sub-keyboards on two opposite sides of the touch screen, for example, the left side and the right side of the touch screen, or the top and the bottom of the touch screen. In the embodiment, a combination of keys of the pair of virtual sub-keyboards is equivalent to keys of a standard virtual keyboard.

In other embodiments, if the determination module determines that the obtained information regarding the detected user operation matches prestored information regarding a third predetermined user operation for rendering a standard virtual sub-keyboard, the generation module 23 generates a standard virtual sub-keyboard having predetermined key configuration structure, and the control module 24 renders the standard virtual sub-keyboard on a fixed position of the touch screen 30, for example, the bottom side of the touch screen 30. In the embodiment, the third predetermined user operation can be touching the information input interface, for example, a long press, a click, a double click, or a predetermined input gesture to the information input interface.

At block 204, the detecting module further detects a user operation applied to the information input interface after the pair of virtual sub-keyboards are rendered, and obtains information regarding the detected user operation.

At block 205, the determination module further determines whether the obtained information regarding the detected user operation matches prestored information regarding a second predetermined user operation for selecting and moving at least one virtual sub-keyboard. In the embodiment, the information regarding the second predetermined user operation can be prestored in the storage device of the electronic device, and the second predetermined user operation can be touching and dragging one or both of the virtual sub-keyboards. If the obtained information regarding the detected user operation matches the prestored information regarding the second predetermined user operation, block 206 is implemented. Otherwise the process remains in block 204.

At block 206, the control module moves the selected virtual sub-keyboard with an input device, such as a finger or a stylus, to a target position where the input device stops.

In other embodiments, the detecting module further detects whether one of the pair of virtual sub-keyboards is moved to contact the other. If the detecting module detects that one of the pair of virtual sub-keyboards is moved to contact the other, the control module renders the standard virtual sub-keyboard to replace the pair of virtual sub-keyboards.

With such a configuration, a user can move the virtual sub-keyboards near a thumb when holding the electronic device in two hands, and then even if the electronic device has big size, the user can flexibly input information on the information input interface by using two thumbs to operate keys of the pair of virtual sub-keyboards.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in particular the matters of shape, size, and arrangement of parts within the principles of the present disclosure, up to and including the full extent established by the broad general meaning of the terms used in the claims.

What is claimed is:

1. An electronic device comprising:
a touch screen;
at least one processor coupled to the touch screen; and
a non-transitory storage device coupled to the processor, the storage device storing one or more programs, which upon execution by the at least one processor, cause the at least one processor to:
detect a user operation applied to an information input interface which is displayed on the touch screen, and obtain information regarding the detected user operation;
determine that the obtained information regarding the detected user operation matches prestored information regarding a first predetermined user operation for rendering a pair of virtual sub-keyboards;
upon such determination, generate a pair of virtual sub-keyboards each having predetermined key configuration structure, wherein a combination of keys of the pair of virtual sub-keyboards is equivalent to keys of a standard virtual keyboard; and
render the pair of virtual sub-keyboards on two opposite sides of the touch screen.

2. The electronic device as described in claim 1, wherein the information regarding the first predetermined user operation is prestored in the storage device of the electronic device, the type of the first predetermined user operation is touching the information input interface at two opposite sides of the touch screen.

3. The electronic device as described in claim 1, wherein the at least one processor is further caused to:
detect a user operation applied to the information input interface after the pair of virtual sub-keyboards are rendered, and obtain information regarding the detected user operation; and
determine that the obtained information regarding the detected user operation matches prestored information regarding a second predetermined user operation for selecting and moving at least one virtual sub-keyboard; and
upon such determination, move the selected virtual sub-keyboard with an input device to a target position where the input device stops.

4. The electronic device as described in claim 3, wherein the at least one processor is further caused to:
detect that one of the pair of virtual sub-keyboards is moved to contact the other; and
upon such detection, renders the standard virtual sub-keyboard to replace the pair of virtual sub-keyboards.

5. The electronic device as described in claim 3, wherein the information regarding the second predetermined user operation is prestored in the storage device of the electronic device, the type of the second predetermined user operation is touching and dragging one or both of the virtual sub-keyboards.

6. The electronic device as described in claim 1, wherein the at least one processor is further caused to:
determine that the obtained information regarding the detected user operation matches prestored information regarding a third predetermined user operation for rendering a standard virtual sub-keyboard;
upon such determination, generate a standard virtual sub-keyboard having predetermined key configuration structure; and
render the standard virtual sub-keyboard on a fixed position of the touch screen.

7. A computer-implemented method for displaying virtual keyboard in an electronic device being executed by a processor of the electronic device, the method comprising:
detecting a user operation applied to an information input interface which is displayed on a touch screen of the electronic device, and obtaining information regarding the detected user operation;
determining that the obtained information regarding the detected user operation matches prestored information regarding a first predetermined user operation for rendering a pair of virtual sub-keyboards;
upon such determination, generating a pair of virtual sub-keyboards each having predetermined key configuration structure, wherein a combination of keys of the pair of virtual sub-keyboards is equivalent to keys of a standard virtual keyboard; and
rendering the pair of virtual sub-keyboards on two opposite sides of the touch screen.

8. The method as described in claim 7, wherein the information regarding the first predetermined user operation is prestored in a storage device of the electronic device, the type of the first predetermined user operation is touching the information input interface at two opposite sides of the touch screen.

9. The method as described in claim 7, further comprising:
detecting a user operation applied to the information input interface after the pair of virtual sub-keyboards are rendered, and obtaining information regarding the detected user operation; and
determining that the obtained information regarding the detected user operation matches prestored information regarding a second predetermined user operation for selecting and moving at least one virtual sub-keyboard; and
upon such determination, moving the selected virtual sub-keyboard with an input device to a target position where the input device stops.

10. The method as described in claim 9, further comprising:
detecting that one of the pair of virtual sub-keyboards is moved to contact the other; and
upon such detection, rendering the standard virtual sub-keyboard to replace the pair of virtual sub-keyboards.

11. The method as described in claim 9, wherein the information regarding the second predetermined user operation is prestored in a storage device of the electronic device, the type of the second predetermined user operation is touching and dragging one or both of the virtual sub-keyboards.

12. The method as described in claim 7, further comprising:
determining that the obtained information regarding the detected user operation matches prestored information regarding a third predetermined user operation for rendering a standard virtual sub-keyboard;
upon such determination, generating a standard virtual sub-keyboard having predetermined key configuration structure; and
rendering the standard virtual sub-keyboard on a fixed position of the touch screen.

13. A non-transitory storage medium having stored thereon instructions that, when executed by at least one processor of an electronic device, causing the at least one processor to perform a method for displaying virtual keyboard in the electronic device, the method comprising:
detecting a user operation applied to an information input interface which is displayed on a touch screen of the electronic device, and obtaining information regarding the detected user operation;
determining that the obtained information regarding the detected user operation matches prestored information regarding a first predetermined user operation for rendering a pair of virtual sub-keyboards;
upon such determination, generating a pair of virtual sub-keyboards each having predetermined key configuration structure, wherein a combination of keys of the pair of virtual sub-keyboards is equivalent to keys of a standard virtual keyboard; and
rendering the pair of virtual sub-keyboards on two opposite sides of the touch screen.

14. The non-transitory storage medium as described in claim 13, wherein the information regarding the first predetermined user operation is prestored in a storage device of the electronic device, the type of the first predetermined user operation is touching the information input interface at two opposite sides of the touch screen.

15. The non-transitory storage medium as described in claim 13, wherein the method further comprising:
detecting a user operation applied to the information input interface after the pair of virtual sub-keyboards are rendered, and obtaining information regarding the detected user operation; and
determining that the obtained information regarding the detected user operation matches prestored information regarding a second predetermined user operation for selecting and moving at least one virtual sub-keyboard; and
upon such determination, moving the selected virtual sub-keyboard with an input device to a target position where the input device stops.

16. The non-transitory storage medium as described in claim 15, wherein the method further comprising:
detecting that one of the pair of virtual sub-keyboards is moved to contact the other; and
upon such detection, rendering the standard virtual sub-keyboard to replace the pair of virtual sub-keyboards.

17. The non-transitory storage medium as described in claim 15, wherein the information regarding the second predetermined user operation is prestored in a storage device of the electronic device, the type of the second predetermined user operation is touching and dragging one or both of the virtual sub-keyboards.

18. The non-transitory storage medium as described in claim 13, wherein the method further comprising:
determining that the obtained information regarding the detected user operation matches prestored information regarding a third predetermined user operation for rendering a standard virtual sub-keyboard;
upon such determination, generating a standard virtual sub-keyboard having predetermined key configuration structure; and
rendering the standard virtual sub-keyboard on a fixed position of the touch screen.
